(19) United States
(12) Patent Application Publication
(10) Pub. No.: US 2024/0334252 A1
(43) Pub. Date: Oct. 3, 2024

(54) TERMINAL DEVICE, CONTROL METHOD FOR TERMINAL DEVICE, NON-TRANSITORY COMPUTER-READABLE STORAGE MEDIUM STORING PROGRAM

(71) Applicant: SEIKO EPSON CORPORATION, Tokyo (JP)

(72) Inventor: Keiichi MORIMOTO, MATSUMOTO-SHI (JP)

(21) Appl. No.: 18/614,843

(22) Filed: Mar. 25, 2024

(30) Foreign Application Priority Data
Mar. 28, 2023 (JP) 2023-051299

(51) Int. Cl. H04W 28/18; H04L 69/24; H04W 48/18

(52) U.S. Cl. CPC H04W 28/18; H04L 69/24; H04W 48/18

(57) ABSTRACT

A terminal device includes: a first communication processor that establishes a wireless communication connection according to a first wireless communication scheme; a transmission controller that performs control to transmit, to a wireless communication device, instruction information giving an instruction to execute a function installed in the wireless communication device, using the wireless communication connection according to the first wireless communication scheme; a second communication processor that establishes, with the wireless communication device, a wireless communication connection according to a second wireless communication scheme conforming to a NAN standard; and a state information acquisition unit that acquires state information representing a state of the wireless communication device from the wireless communication device, using the wireless communication connection according to the second wireless communication scheme, when a response to the instruction information is not given.

The present application is based on, and claims priority from JP Application Serial Number 2023-051299, filed Mar. 28, 2023, the disclosure of which is hereby incorporated by reference herein in its entirety.

### BACKGROUND

### 1. Technical Field

The present disclosure relates to a terminal device, a control method for a terminal device, and a non-transitory computer-readable storage medium storing a program.

### 2. Related Art

A technique of printing using wireless communication is known. For example, JP-A-2018-19146 discloses a technique in which a terminal device and a printing device are connected for wireless communication to an access point and in which data is transmitted by wireless communication from the terminal device to the printing device via the access point, thus implementing printing.

In the technique disclosed in JP-A-2018-19146, when a problem has occurred in the wireless communication connection between the printing device and the access point, printing is not executed even when a print instruction is transmitted from the terminal device. In this case, the terminal device cannot communicate with the printing device via the access point and therefore cannot check the state of the printing device. Thus, a technique for enabling the terminal device to check the state of a wireless communication device such as a printing device even when the terminal device cannot communicate with the wireless communication device via an access point is demanded.

### SUMMARY

According to an aspect of the present disclosure, a terminal device includes: a first communication processing unit that establishes a wireless communication connection according to a first wireless communication scheme; a transmission control unit that performs control to transmit, to a wireless communication device, instruction information giving an instruction to execute a function installed in the wireless communication device, using the wireless communication connection according to the first wireless communication scheme; a second communication processing unit that establishes, with the wireless communication device, a wireless communication connection according to a second wireless communication scheme that is a communication scheme conforming to a NAN standard and that is different from the first wireless communication scheme; and a state information acquisition unit that acquires state information representing a state of the wireless communication device from the wireless communication device, using the wireless communication connection according to the second wireless communication scheme, when a response to the instruction information is not given.

According to another aspect of the present disclosure, a control method for a terminal device includes: performing control to transmit, to a wireless communication device, instruction information giving an instruction to execute a function installed in the wireless communication device, using a wireless communication connection according to a first wireless communication scheme; establishing, with the wireless communication device, a wireless communication connection according to a second wireless communication scheme that is a communication scheme conforming to a NAN standard and that is different from the first wireless communication scheme; and acquiring state information representing a state of the wireless communication device from the wireless communication device, using the wireless communication connection according to the second wireless communication scheme, when a response to the instruction information is not given.

According to still another aspect of the present disclosure, a non-transitory computer-readable storage medium storing a program is provided. The program causes a computer to execute: a first communication processing step of establishing a wireless communication connection according to a first wireless communication scheme; a transmission control step of performing control to transmit, to a wireless communication device, instruction information giving an instruction to execute a function installed in the wireless communication device, using the wireless communication connection according to the first wireless communication scheme; a second communication processing step of establishing, with the wireless communication device, a wireless communication connection according to a second wireless communication scheme that is a communication scheme conforming to a NAN standard and that is different from the first wireless communication scheme; and a state information acquisition step of acquiring state information representing a state of the wireless communication device from the wireless communication device, using the wireless communication connection according to the second wireless communication scheme, when a response to the instruction information is not given.

### BRIEF DESCRIPTION OF THE DRAWINGS

FIG. 1 is a schematic view showing an example of the configuration of a communication system according to an embodiment.

FIG. 2 is a block diagram showing an example of the configuration of a terminal device according to the embodiment.

FIG. 3 is a block diagram showing an example of the configuration of a wireless communication device according to the embodiment.

FIG. 4 is a flowchart showing an example of a flow of operations of the terminal device according to the embodiment.

FIG. 5 is a flowchart showing an example of a flow of operations of the wireless communication device according to the embodiment.

### DESCRIPTION OF EMBODIMENTS

An embodiment will now be described with reference to the drawings. To clarify the description, suitable omissions and simplifications are made in the description and drawings given below. In the drawings, the same elements are denoted by the same reference sign and a duplicate description of such elements is omitted according to need.

In Wi-Fi Aware, which is a program certified by the Wi-Fi Alliance, a communication protocol called NAN (Neighbor Awareness Networking) for wireless communication between devices without using an access point is prescribed. Hereinafter, a standard for the NAN defined by the Wi-Fi Alliance is referred to as the NAN standard. In the embodiment described below, communication conforming to the NAN standard is performed as well as communication via an access point.

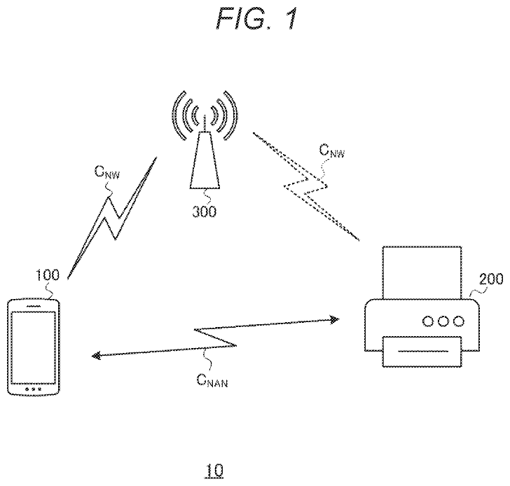

FIG. 1 is a schematic view showing an example of the configuration of a communication system 10 according to the embodiment. The communication system 10 includes a terminal device 100, a wireless communication device 200, and an access point 300. The access point 300 is an access point of a wireless LAN (local area network). The wireless LAN is specifically, for example, a Wi-Fi (trademark registered) network.

In this embodiment, the terminal device 100 uses a function installed in the wireless communication device 200, by communication via the access point 300. The wireless communication device 200 executes the function installed in the wireless communication device 200, based on an instruction received from the terminal device 100 by communication via the access point 300. In this embodiment, the function installed in the wireless communication device 200 is, for example, a print function. However, the function installed in the wireless communication device 200 is not limited to the print function and may be any function such as a scan function.

In the communication system 10, in a case such as when a problem has occurred in the wireless communication connection between the wireless communication device 200 and the access point 300, the function of the wireless communication device 200 is not executed even when an instruction is transmitted from the terminal device 100. In this case, the terminal device 100 cannot communicate with the wireless communication device 200 via the access point 300 and therefore cannot check the state of the wireless communication device 200 by communication via the access point 300. Thus, in this embodiment, the terminal device 100 checks the state of the wireless communication device 200 by communication conforming to the NAN standard.

In the present disclosure, a wireless communication scheme to perform communication via the access point 300 is referred to as a NW (network) wireless communication scheme. The NW wireless communication scheme can also be said to be a method for performing communication via the access point 300 in conformity with the Wi-Fi (trademark registered) standard and can also be said to be a wireless communication scheme in an infrastructure mode. In the present disclosure, a communication scheme conforming to the NAN standard is also referred to as a NAN wireless communication scheme. In FIG. 1, a wireless communication connection C_{NW} according to the NW wireless communication scheme with the terminal device 100 is properly established, whereas a wireless communication connection C_{NW} according to the NW wireless communication scheme with the wireless communication device 200 has a problem. Therefore, the terminal device 100 checks the state of the wireless communication device 200 by communication C_{NAN} according to the NAN wireless communication scheme, as will be described later.

The terminal device 100 is, for example, a device operated by a user, such as a PC (personal computer), a smartphone, or a tablet terminal. In this embodiment, the wireless communication device 200 is, for example, a printing device (printer). In the communication system 10, the terminal device 100 and the wireless communication device 200 perform communication according to the NAN wireless communication scheme, that is, communication conforming to the NAN standard, as described above.

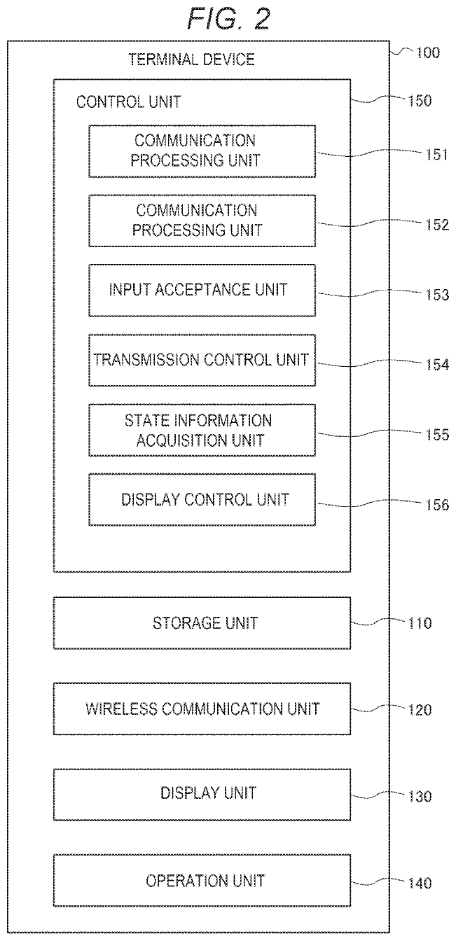

The specific configuration of and processing by the terminal device 100 and the wireless communication device 200 will now be described. First, the terminal device 100 will be described. FIG. 2 is a block diagram showing an example of the configuration of the terminal device 100. As shown in FIG. 2, the terminal device 100 has a storage unit 110, a wireless communication unit 120, a display unit 130, an operation unit 140, and a control unit 150.

The storage unit 110 is a storage device in which a program to implement the processing by the control unit 150 and data used for the processing by the terminal device 100 are stored. The storage device may be, for example, a non-volatile storage device such as a hard disk or a flash memory or may include a memory such as a RAM (random-access memory).

The wireless communication unit 120 is hardware to perform wireless communication. That is, the wireless communication unit 120 is a wireless communication interface. The wireless communication unit 120 can include a transmission circuit, a reception circuit, and an antenna.

The display unit 130 and the operation unit 140 are a user interface. The display unit 130 is formed of a display or the like that displays various information to the user. The operation unit 140 is formed of a button or the like that accepts an input operation from the user. The display unit 130 and the operation unit 140 may be formed as one unit made up of a touch panel or the like.

The control unit 150 is a processor such as a CPU (central processing unit) that controls each component of the terminal device 100. The control unit 150 may have a plurality of processors. The control unit 150 reads a program into the memory and executes the program. Thus, in this embodiment, the control unit 150 executes the processing of a communication processing unit 151, a communication processing unit 152, an input acceptance unit 153, a transmission control unit 154, a state information acquisition unit 155, and a display control unit 156.

The terminal device 100 has the communication processing unit 151 and the communication processing unit 152 and is thus configured to be able to communicate according to two different types of wireless communication schemes.

The communication processing unit 151 performs processing of executing communication according to the NW wireless communication scheme. This processing includes processing of establishing a wireless communication connection according to the NW wireless communication scheme. Specifically, the communication processing unit 151 establishes a wireless communication connection according to the NW wireless communication scheme with the access point 300, using the SSID (Service Set Identifier) of the access point 300 and a password.

The communication processing unit 152 performs processing of executing communication according to the NAN wireless communication scheme with the wireless communication device 200. This processing includes processing of establishing a wireless communication connection according to the NAN wireless communication scheme with the wireless communication device 200. Specifically, the communication processing unit 152 causes the terminal device 100 to belong to a NAN cluster, described later, in conformity with the NAN standard, and subsequently establishes a wireless communication connection conforming to the NAN standard with the wireless communication device 200 belonging to this NAN cluster. Hereinafter, the wireless communication connection conforming to the NAN standard, that is, the wireless communication connection according to the NAN wireless communication scheme, is also referred to as a NAN connection. In this embodiment, the wireless communication connection conforming to the NAN standard is specifically a NAN data link. Details of processing by the communication processing unit 152 to establish the NAN connection (NAN data link) between the terminal device 100 and the wireless communication device 200 will be described later. In this embodiment, the communication processing unit 152 establishes the NAN connection with the wireless communication device 200 when a response is not given to instruction information transmitted from the terminal device 100 using the wireless communication connection according to the NW wireless communication scheme. However, the communication processing unit 152 may establish the NAN connection with the wireless communication device 200 regardless of whether a response is given or not. For example, the communication processing unit 152 may establish the NAN connection n before the transmission of the instruction information or may establish the NAN connection immediately after the transmission of the instruction information.

The input acceptance unit 153 accepts an instruction, information or the like inputted by the user via the operation unit 140. In this embodiment, the input acceptance unit 153 accepts an instruction to execute the function of the wireless communication device 200. Specifically, the input acceptance unit 153 accepts a print instruction inputted by the user via the operation unit 140. This instruction may include an instruction to designate a device to execute the function, that is, an instruction to designate the wireless communication device 200. This instruction may also include an instruction to designate data of a print target. This instruction may also include an instruction to designate a print setting.

The transmission control unit 154 controls the transmission of information using the wireless communication connection according to the NW wireless communication scheme or the wireless communication connection according to the NAN wireless communication scheme. Particularly in this embodiment, the transmission control unit 154 performs control to transmit, to the wireless communication device 200, the instruction information giving an instruction to execute the function installed in the wireless communication device 200, using the wireless communication connection according to the NW wireless communication scheme. For example, when the input acceptance unit 153 has accepted the print instruction, the transmission control unit 154 performs control to transmit instruction information giving an instruction to execute printing, to the wireless communication device 200, using the wireless communication connection according to the NW wireless communication scheme. The instruction information giving an instruction to execute printing may include data of a print target or may include information that designates a print setting.

When a problem has occurred in the wireless communication connection according to the NW wireless communication scheme of the wireless communication device 200, even when the terminal device 100 transmits the instruction information, the terminal device 100 cannot be given a response to this instruction information, from the wireless communication device 200. Thus, in this embodiment, when a response to the instruction information is not given, the terminal device 100 checks the state of the wireless communication device 200, using the wireless communication connection according to the NAN wireless communication scheme, as will be described later.

When a response is not given from the wireless communication device 200 to the instruction information transmitted by the terminal device 100, the transmission control unit 154 may perform control to transmit the instruction information to the wireless communication device 200, using the NAN connection. That is, the transmission control unit 154 may perform control to re-transmit, using the NAN connection, the instruction information transmitted using the wireless communication connection according to the NW wireless communication scheme. Thus, the function of the wireless communication device 200 can be used even when the instruction information cannot be transmitted by the wireless communication connection according to the NW wireless communication scheme. Particularly, the transmission control unit 154 may perform control to re-transmit the instruction information, using the NAN connection, only when the state information acquired by the state information acquisition unit 155, described later, does not indicate any abnormality in the function designated to be executed by the instruction information. In other words, the transmission control unit 154 may perform control not to transmit the instruction information, using the NAN connection, when the acquired I state information indicates an abnormality in the function. Thus, the transmission of the instruction information despite the inability to execute the function can be prevented. In this embodiment, the abnormality in the function may be any abnormality that prevents the execution of the function. For example, the abnormality in the function may be an abnormality in a mechanical component element of the wireless communication device 200 that operates to execute the function or may be a shortage of a consumable item installed in the wireless communication device 200 to execute the function. Specifically, for example, the abnormality in the function may be the occurrence of a paper jam in the wireless communication device 200 as a printing device or may be a shortage of a color material or a paper (recording medium) in the wireless communication device 200.

The transmission control unit 154 may perform such re-transmission of the instruction information in response to an instruction from the user. That is, the transmission control unit 154 may perform control to re-transmit the instruction information when the input acceptance unit 153 has accepted an instruction to transmit the instruction information using the NAN connection. The transmission control unit 154 may also transmit the instruction information using the NAN connection after checking that the state information indicating a defect in the wireless communication connection according to the NW wireless communication scheme of the wireless communication device 200 is acquired.

The state information acquisition unit 155 acquires the state information representing the state of the wireless communication device 200 from the wireless communication device 200, using the NAN connection, when a response is not given from the wireless communication device 200 to the instruction information transmitted using the wireless communication connection according to the NW wireless communication scheme. For example, the state information acquisition unit 155 requests the wireless communication device 200 to transmit the state information, via the NAN connection, when a response is not acquired from the wireless communication device 200 even with the lapse of a predetermined time after the instruction information is transmitted using the wireless communication connection according to the NW wireless communication scheme. Thus, the state information acquisition unit 155 acquires the state information from the wireless communication device 200 via the NAN connection.

In this embodiment, particularly, the state information acquisition unit 155 acquires information about the state of the wireless communication connection according to the NW wireless communication scheme of the wireless communication device 200, as the state information. To describe this more in detail, in this embodiment, the state information acquisition unit 155 acquires the result of a diagnosis about the state of the wireless communication connection according to the NW wireless communication scheme of the wireless communication device 200 carried out by the wireless communication device 200, as the information about the state of the wireless communication connection. In this way, the state information acquired by the state information acquisition unit 155 may include information representing the result of the diagnosis by the wireless communication device 200 about the state of the wireless communication connection according to the NW wireless communication scheme of the wireless communication device 200. Thus, the result of the self-diagnosis of the wireless communication device 200 about the wireless communication connection (specifically, processing by a diagnosis unit 243, described later) can be utilized remotely.

The state information acquisition unit 155 may acquire reference information from the wireless communication device 200 along with the result of the diagnosis about the state of the wireless communication connection according to the NW wireless communication scheme of the wireless communication device 200, using the NAN connection. The reference information is information which the user should refer to in order to solve the defect in the wireless communication connection according to the NW wireless communication scheme of the wireless communication device 200. Specifically, the reference information may be, for example, an instruction manual describing a task which the user should perform in order to solve the defect in the wireless communication connection.

The state information acquisition unit 155 may acquire information representing the state about the function of the wireless communication device 200, as the state information. That is, the state information acquired by the state information acquisition unit 155 may include information representing the state about the function of the wireless communication device 200. To describe this more in detail, the function of the wireless communication device 200 in this case can be said to be a function provided by the wireless communication device 200 in response to a request from the terminal device 100. The information representing the state about the function may be information representing whether there is an abnormality in the function or not. When an abnormality has occurred in the function, the information representing the state about the function may include information representing the content of the abnormality in the function. For example, the information representing the state about the function may represent the occurrence of an abnormality in a mechanical component element, the occurrence of an abnormality due to a shortage of a consumable item, or the like. In this embodiment, the state information acquisition unit 155 acquires the result of the diagnosis about the function of the wireless communication device 200 caried out by the wireless communication device 200, as the information representing the state about the function, as will be described later. When the wireless communication device 200 has various functions, the state information acquisition unit 155 may acquire information representing the state about the function for all the functions or may acquire information representing the state about the function for a specified function. In the case of acquiring the information representing the state about the function for a specified function, the state information acquisition unit 155 may notify the wireless communication device 200 of a function for which the state information needs to be acquired, when requesting the wireless communication device 200 to transmit the state information. In this case, the state information acquisition unit 155 may notify the wireless communication device 200 of a function designated to be executed by the instruction information transmitted via the wireless communication connection according to the NW wireless communication scheme.

The state information acquisition unit 155 may acquire information about the remaining amount of a consumable item (for example, a color material, a paper, or the like) installed in the wireless communication device 200 in order to execute the function, as the information representing the state about the function. That is, the state information acquired by the state information acquisition unit 155 may include information about the remaining amount of the consumable item installed in the wireless communication device 200 in order to execute the function of the wireless communication device 200. The information about the remaining amount of the consumable item may represent whether the remaining amount of the consumable item is insufficient for the execution of the function or not, or may represent the remaining amount of the consumable item itself.

The display control unit 156 controls the display by the display unit 130. In this embodiment, the display control unit 156 performs control to display the information acquired by the state information acquisition unit 155, on the display unit 130. That is, the display control unit 156 performs control to display the state information transmitted from the wireless communication device 200. When the state information represents a shortage of a consumable item in the wireless communication device 200, the display control unit 156 may perform control to display a warning that gives a notification of the shortage of the consumable item. As the state information is displayed, the user can grasp the state of the wireless communication device 200 and the convenience for the user is thus improved. As the warning of the shortage of the consumable item is displayed, the user can be prompted to replenish the consumable item.

When the state information acquisition unit 155 has acquired the foregoing reference information, the display control unit 156 may perform control to display this reference information. The display control unit 156 may also perform control to display reference information acquired from a device other than the wireless communication device 200. For example, the storage unit 110 of the terminal device 100 may store reference information in advance. In this case, the display control unit 156 may perform control to display the reference information stored in the storage unit 110, on the display unit 130. At this point, the display control unit 156 may perform control to display the reference information corresponding to the result of the diagnosis of the wireless communication device 200, included in the state information acquired by the state information acquisition unit 155. That is, the display control unit 156 may perform control to extract and display only the reference information corresponding to the result of the diagnosis, from among various pieces of reference information stored in the storage unit 110. As the reference information is displayed, the user can easily acquire information that helps the user to solve the trouble in the wireless communication connection and the convenience for the user is thus improved.

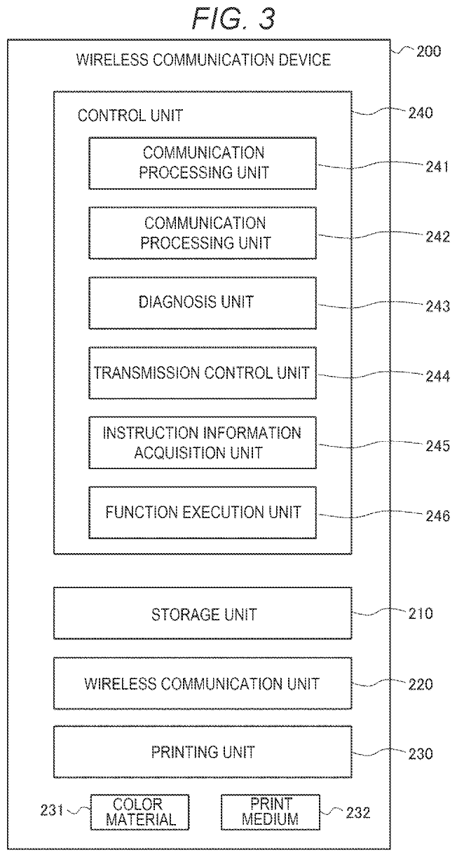

The wireless communication device 200 will now be described. FIG. 3 is a block diagram showing an example of the configuration of the wireless communication device 200. As shown in FIG. 3, the wireless communication device 200 has a storage unit 210, a wireless communication unit 220, a printing unit 230, and a control unit 240. The wireless communication device 200 also has a color material 231 and a print medium 232 for a print function to be executed by the printing unit 230. The color material 231 and the print medium 232 are an example of the foregoing consumable item. The wireless communication device 200 may also have other component elements. For example, the wireless communication device 200 may also have a user interface such as a touch panel display or may also have a scanner or the like.

The storage unit 210 is a storage device in which a program to implement the processing by the control unit 240 and data used for the processing by the wireless communication device 200 are stored. The storage device may be, for example, a non-volatile storage device such as a hard disk or a flash memory or may include a memory such as a RAM.

The wireless communication unit 220 is hardware to perform wireless communication. That is, the wireless communication unit 220 is a wireless communication interface. The wireless communication unit 220 can include a transmission circuit, a reception circuit, and an antenna.

The printing unit 230 has a configuration to print on the print medium 232 such as a paper. Specifically, for example, the printing unit 230 includes a print engine. The print engine is a mechanical configuration to execute printing of an image on the print medium 232, using the color material 231. The print engine may have, for example, a mechanism to perform printing using an ink, which is the color material 231, by an inkjet method. Alternatively, the print engine may have, for example, a mechanism to perform printing using a toner, which is the color material 231, by an electrophotographic method. The printing unit 230 may also have a conveyance mechanism to convey the print medium 232.

The control unit 240 is a processor such as a CPU that controls each component of the wireless communication device 200. The control unit 240 may have a plurality of processors. The control unit 240 reads a program into the memory and executes the program. Thus, in this embodiment, the control unit 240 executes the processing of a communication processing unit 241, a communication processing unit 242, the diagnosis unit 243, a transmission control unit 244, an instruction information acquisition unit 245, and a function execution unit 246.

The wireless communication device 200 has the communication processing unit 241 and the communication processing unit 242 and is thus configured to be able to communicate according to two different types of wireless communication schemes.

The communication processing unit 241 performs processing of executing communication according to the NW wireless communication scheme. This processing includes processing of establishing a wireless communication connection according to the NW wireless communication scheme. Specifically, the communication processing unit 241 establishes a wireless communication connection according to the NW wireless communication scheme with the access point 300, using the SSID of the access point 300 and a password.

The communication processing unit 242 performs processing of executing communication according to the NAN wireless communication scheme with the terminal device 100 This processing includes processing of establishing a NAN connection with the terminal device 100. Details of processing by the communication processing unit 242 to establish the NAN connection between the terminal device 100 and the wireless communication device 200 will be described later.

The diagnosis unit 243 diagnoses the state of the wireless communication device 200 and generates state information representing the state of the wireless communication device 200. That is, the diagnosis unit 243 generates state information including the result of the diagnosis. The diagnosis unit 243 diagnoses the state of the wireless communication connection according to the NW wireless communication scheme. For example, the diagnosis unit 243 executes a ping command and transmits a packet to the access point 300 and thus diagnoses the state of the wireless communication connection according to the NW wireless communication scheme. Specifically, the diagnosis unit 243 checks a response to the packet transmitted through the execution of the ping command and thus determines whether the wireless communication connection according to the NW wireless communication scheme is in a properly established state or in a defective state. The defective state includes not only a state where the wireless communication connection is not established but also a state where the connection is unstable. The diagnosis unit 243 determines that the wireless communication connection is not established, for example, when a response to the packet transmitted through the execution of the ping command is not acquired. The diagnosis unit 243 determines that the wireless communication connection is unstable when the time until a response to the packet transmitted through the execution of the ping command is acquired exceeds a threshold. While the execution of the ping command is used here as an example of the method for diagnosing the state of the wireless communication connection according to the NW wireless communication scheme, this method is not limiting. The diagnosis unit 243 may also diagnose the state of the wireless communication connection by using another known diagnostic technique. The diagnosis unit 243 may also generate state information including setting information that is currently set for the wireless communication connection according to the NW wireless communication scheme. For example, the diagnosis unit 243 may generate state information including setting information (for example, one or both of an SSID and a password) used for the connection with the access point 300 or may generate state information including an IP (Internet Protocol) address that is currently allocated to the wireless communication device 200.

The diagnosis unit 243 may also diagnose the state of a function that is installed in the wireless communication device 200 and that is provided in response to a request from another device, and thus may generate state information. In this embodiment, specifically, the diagnosis unit 243 may diagnose the state of the print function. For example, the diagnosis unit 243 may determine whether there is an abnormality in the printing unit 230 or not, or may diagnose the degree of shortage of the consumable item such as the color material 231 or the print medium 232. The abnormality in the printing unit 230 may be a malfunction of a component forming the printing unit 230 or the occurrence of a paper jam or the like. The diagnosis unit 243 may diagnose the state of the function, using a known diagnostic technique installed in the wireless communication device 200. For example, the diagnosis unit 243 may check a signal from a sensor that detects a malfunction of the printing unit 230 or a sensor that detects a paper jam, and thus may detect an abnormality in the printing unit 230. The diagnosis unit 243 may also check a signal from a sensor that detects the remaining amount of the consumable item, and thus may diagnose the degree of shortage of the consumable item.

The transmission control unit 244 controls the transmission of information using the wireless communication connection according to the NW wireless communication scheme or the wireless communication connection according to the NAN wireless communication scheme. Particularly in this embodiment, the transmission control unit 244 performs control to transmit the state information generated by the diagnosis unit 243 to the terminal device 100, using the wireless communication connection according to the NAN wireless communication scheme, that is, the NAN connection. For example, when the transmission control unit 244 has received a request to transmit the state information, from the terminal device 100 via the NAN connection, the transmission control unit 244 performs control to transmit the state information to the terminal device 100. The state information to be transmitted may include the result of a diagnosis carried out by the diagnosis unit 243 in response to the request to transmit the state information, from the terminal device 100, or may include the result of the latest diagnosis, of the results of diagnoses performed periodically by the diagnosis unit 243.

The transmission control unit 244 may transmit the foregoing reference information along with the state information to the terminal device 100, using the NAN connection. In this case, the transmission control unit 244 performs control, for example, to transmit the reference information stored in advance in the storage unit 210 of the wireless communication device 200. The transmission control unit 244 may perform control to extract and transmit only the reference information corresponding to the result of the diagnosis by the diagnosis unit 243, from among various pieces of reference information stored in the storage unit 210.

As described above, the state information to be transmitted may be information representing the state about the function of the wireless communication device 200. When the wireless communication device 200 has a plurality of various functions, the transmission control unit 244 may perform control to transmit the state information about a function designated by the terminal device 100. The transmission control unit 244 may also perform control to transmit information about the remaining amount of consumable item (for example, the color material 231 and the print medium 232) installed in the wireless communication device 200 in order to execute the function, as the state information about the function.

The instruction information acquisition unit 245 acquires instruction information from the terminal device 100, using the wireless communication connection according to the NW wireless communication scheme established by the communication processing unit 241 or the NAN connection established by the communication processing unit 242. In this embodiment, specifically, the instruction information acquisition unit 245 acquires instruction information giving an instruction to execute printing, from the terminal device 100. When the instruction information acquisition unit 245 has acquired instruction information from the terminal device 100, the instruction information acquisition unit 245 returns a response to the terminal device 100, using the wireless communication connection used for the transmission of this instruction information. This response may be a packet giving a notification that the instruction information is accepted, or may be a packet indicating the result of execution of the function, or the like.

The function execution unit 246 performs processing to execute the function of the wireless communication device 200. Specifically, the function execution unit 246 performs processing to execute the function according to the instruction information acquired by the instruction information acquisition unit 245. In this embodiment, specifically, the function execution unit 246 executes printing according to the instruction information giving an instruction to execute printing, using the printing unit 230.

Details of the processing by the communication processing unit 152 and the communication processing unit 242 to establish a NAN connection between the terminal device 100 and the wireless communication device 200 will now be described. To establish a NAN connection, the terminal device 100 and the wireless communication device 200 first configure a NAN cluster. Subsequently, the terminal device 100 and the wireless communication device 200 construct a NAN connection, that is, a NAN data link.

The NAN standard prescribes a period called a discovery window (DW). The discovery window is a communication period generated intermittently mainly for a device to report and search for a service. The discovery window arrives on a predetermined cycle. A set of devices sharing the discovery window is called a NAN cluster. A device operating as a master transmits a discovery beacon to recognize the NAN cluster, to another device yet to belong to the NAN cluster. The device operating as the master transmits a synchronization beacon for each device to synchronize with the discovery window. In this embodiment, the terminal device 100 may operate as the master or the wireless communication device 200 may operate as the master.

Each device forming the NAN cluster transmits and receives a signal within the discovery window and thus can check a service provided by each device. Specifically, a signal formed of a frame in a format called a service discovery frame is transmitted within the discovery window.

The device forming the NAN cluster can establish a data link that enables mutual communication without being limited to the discovery window period, with another device forming the NAN cluster. That is, the NAN connection can be made between the devices forming the NAN cluster. According to the NAN standard, the foregoing data link is called the NAN data link.

In order for the terminal device 100 and the wireless communication device 200 to establish the NAN connection, the terminal device 100 and the wireless communication device 200 first need to share the discovery window. To share the discovery window, one of the terminal device 100 and the wireless communication device 200 operates as the master. For example, when the terminal device 100 operates as the master, the communication processing unit 152 of the terminal device 100 performs processing of transmitting a discovery beacon and a synchronization beacon from the terminal device 100. In response to this, the communication processing unit 242 of the wireless communication device 200 performs processing of synchronizing with the discovery window, that is, NAN synchronization, based on the discovery beacon and the synchronization beacon transmitted from the terminal device 100.

When the terminal device 100 and the wireless communication device 200 have shared the discovery window, the communication processing unit 152 of the terminal device 100 specifies the wireless communication device 200 of the destination of transmission of the instruction information transmitted using the wireless communication connection according to the NW wireless communication scheme, from among the NAN cluster (that is, the group of devices sharing the discovery window). That is, the communication processing unit 152 specifies the device to be requested to provide the state information. In other words, the communication processing unit 152 specifies the device of the connection target of the NAN connection to be established in order to acquire the state information. In this embodiment, the communication processing unit 152 specifies the connection target of the NAN connection from among the NAN cluster, based on the MAC (media access control) address of the wireless communication device 200 of the destination of transmission of the instruction information transmitted by the wireless communication connection according to the NW wireless communication scheme. Thus, the connection target of the NAN connection can be properly specified. The MAC address is acquired and stored in the storage unit 110, for example, during the time when the communication by the wireless communication connection according to the NW wireless communication scheme is normally performed between the terminal device 100 and the wireless communication device 200. The communication processing unit 152 checks, for example, the MAC address included in the service discovery frame transmitted from the device forming the NAN cluster, and thus checks the MAC address of each device forming the NAN cluster. The communication processing unit 152 may broadcast a message inquiring about the service of each device, to each device forming the NAN cluster, in order for another device to transmit the service discovery frame.

When the communication processing unit 152 of the terminal device 100 has specified the wireless communication device 200 of the connection target of the NAN connection, the communication processing unit 152 of the terminal device 100 and the communication processing unit 242 of the wireless communication device 200 execute processing of establishing the NAN data link according to a connection procedure conforming to the NAN standard. Thus, the NAN connection is established between the terminal device 100 and the wireless communication device 200.

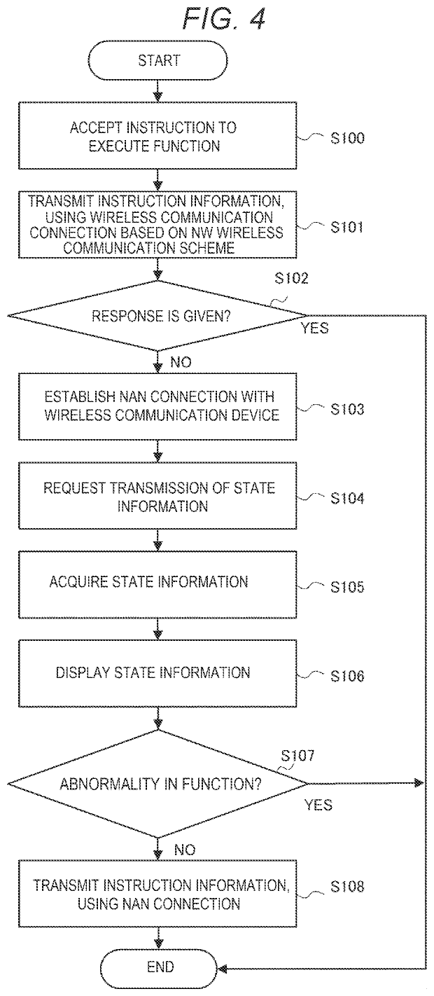

A flow of operations of the terminal device 100 and a flow of operations of the wireless communication device 200 will now be described. First, the flow of operations of the terminal device 100 will be described. FIG. 4 is a flowchart showing an example of the flow of operations of the terminal device 100 according to the embodiment Hereinafter, the flow of operations will be described with reference to FIG. 4. It is assumed that the terminal device 100 has normally established the wireless communication connection according to the NW wireless communication scheme before the operations described below.

In step S100, the input acceptance unit 153 accepts, from the user, an instruction to execute the function of the wireless communication device 200. In this embodiment, specifically, the input acceptance unit 153 accepts a print instruction.

Next, in step S101, the transmission control unit 154 of the terminal device 100 performs control to transmit instruction information corresponding to the instruction accepted in step S100 to the wireless communication device 200, using the wireless communication connection according to the NW wireless communication scheme. The transmission control unit 154 performs control, for example, to transmit the instruction information to the wireless communication device 200 designated by the input acceptance unit 153, but may transmit the instruction information to a predetermined wireless communication device 200. The wireless communication device 200 that is the destination of transmission of the instruction information transmitted by the wireless communication connection according to the NW wireless communication scheme is, for example, the wireless communication device 200 that has been successful in the communication by the wireless communication connection according to the NW wireless communication scheme with the terminal device 100 in the past. However, the wireless communication device 200 that is the destination of transmission of the instruction information transmitted by the wireless communication connection according to the NW wireless communication scheme may be a device whose IP address is specified in advance, and may not necessarily be the wireless communication device 200 that has been successful in the communication by the wireless communication connection according to the NW wireless communication scheme with the terminal device 100 in the past.

When a response is given from the wireless communication device 200 of the destination of transmission to the instruction information transmitted in step S101 (YES in step S102), the instruction information is normally transmitted and therefore the processing by the terminal device 100 ends. Meanwhile, when a response is not given from the wireless communication device 200 (NO in step S102), the processing shifts to step S103.

For example, in the following cases, a response from the wireless communication device 200 is not acquired. For example, when the wireless communication device 200 has not configured a setting for wireless communication connection with a new access point 300 even when the access point 300 is replaced, the terminal device 100 can no longer communicate with the wireless communication device 200, with which the terminal device 100 was able to normally communicate in the past. Therefore, the terminal device 100 cannot acquire a response. Also, when the electromagnetic environment between the access point 300 and the wireless communication device 200 is changed due to a change in the relative positional relationship between the access point 300 and the wireless communication device 200 or the like, the terminal device 100 may not be able to normally communicate with the wireless communication device 200. Also, when the terminal device 100 has transmitted the instruction information using the IP address before the update of the wireless communication device 200 even when the IP address of the wireless communication device 200 is updated by a DHCP (Dynamic Host Configuration Protocol) server or the like, the terminal device 100 cannot acquire a response from the wireless communication device 200. While the cases where a response is not acquired from the wireless communication device 200 are described above, these cases are simply examples. The processing may shift to step S103 in other cases than the foregoing cases.

In step S103, the communication processing unit 152 of the terminal device 100 establishes the NAN connection with the wireless communication device 200. As described above, in order to establish the NAN connection, the communication processing unit 152 executes the processing conforming to the NAN standard and causes the terminal device 100 to belong to the NAN cluster. Subsequently, the communication processing unit 152 specifies the wireless communication device 200 that is the destination of transmission of the instruction information in step S101, from among the devices forming the NAN cluster, and establishes the NAN connection.

Next, in step S104, the state information acquisition unit 155 requests the wireless communication device 200 to transmit the state information, via the NAN connection established in step S103. Then, in step S105, the state information acquisition unit 155 acquires the state information from the wireless communication device 200 via the NAN connection established in step S103. As described above, in this step, the state information acquisition unit 155 can also acquire the reference information from the wireless communication device 200 via the NAN connection.

Next, in step S106, the display control unit 156 performs control to display the state information acquired in step S105, on the display unit 130. When the reference information, too, is acquired in step S105, the display control unit 156 performs control to also display the reference information on the display unit 130. As described above, the display control unit 156 may perform control to display, on the display unit 130, the reference information stored in the storage unit 110 in advance and corresponding to the state of the wireless communication device 200 represented by the acquired state information, instead of the reference information acquired from the wireless communication device 200.

When the state information acquired in step S105 does not indicate an abnormality in the function designated to be executed by the instruction information (NO in step S107), the processing shifts to step S108. Meanwhile, when the state information indicates an abnormality in the function designated to be executed by instruction information (YES in step S107), the function cannot be executed even when the instruction information is transmitted via the NAN connection, and therefore the processing ends.

In step S108, the transmission control unit 154 of the terminal device 100 re-transmits the instruction information that is the transmission target in step S101, to the wireless communication device 200, using the NAN connection established in step S103. Thus, printing is executed at the wireless communication device 200.

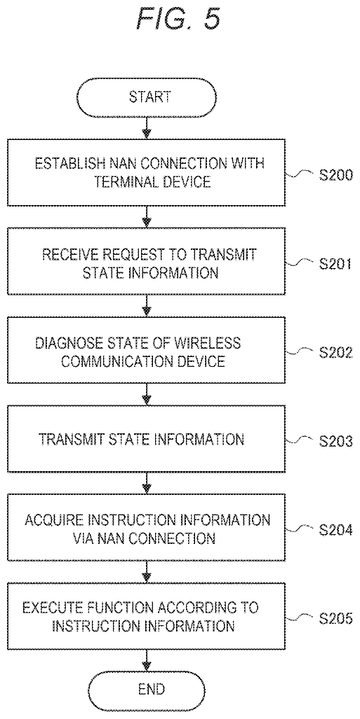

The flow of operations of the wireless communication device 200 in the case where a problem has occurred in the wireless communication connection according to the NW wireless communication scheme at the wireless communication device 200 will now be described. FIG. 5 is a flowchart showing an example of the flow of operations of the wireless communication device 200 according to the embodiment.

Step S200 is a step corresponding to step S103 in FIG. 4. In this step, the communication processing unit 242 of the wireless communication device 200 establishes the NAN connection with the terminal device 100.

The subsequent step S201 is a step corresponding to step S104 in FIG. 4. In this step, the wireless communication device 200 receives a request to transmit the state information, from the terminal device 100 via the NAN connection.

Next, in step S202, the diagnosis unit 243 diagnoses the state of the wireless communication device 200 and generates the state information. In this flowchart, the diagnosis unit 243 performs the diagnosis and the generation of the state information after receiving the request to transmit the state information. However, the diagnosis unit 243 may perform the diagnosis and the generation of the state information before receiving the request to transmit the state information.

Next, in step S203, the transmission control unit 244 of the wireless communication device 200 performs control to transmit the state information generated in step S202 to the terminal device 100, using the NAN connection established in step S200. As described above, the transmission control unit 244 may perform control to transmit the reference information corresponding to the state of the wireless communication device 200 represented by the state information along with the state information, to the terminal device 100, using the NAN connection.

When the terminal device 100 has transmitted the instruction information, using the NAN connection (that is, when the processing of step S108 in FIG. 4 is performed), the wireless communication device 200 performs processing of steps S204 and S205, described below.

In step S204, the instruction information acquisition unit 245 of the wireless communication device 200 acquires the instruction information from the terminal device 100 via the NAN connection established in step S200. Then, in step S205, the function execution unit 246 performs processing of executing the function according to the instruction information acquired in step S204. That is, the function execution unit 246 executes printing according to the instruction information, using the printing unit 230.

An embodiment has been described above. According to this embodiment, when a response is not given to instruction information transmitted using the wireless communication connection according to the NW wireless communication scheme, state information is transmitted using the NAN connection. Therefore, even when the terminal device 100 cannot communicate with the wireless communication device 200, using the wireless communication connection according to the NW wireless communication scheme, the terminal device 100 can check the state of the wireless communication device 200.

While an embodiment has been described above, the present disclosure is not limited to this embodiment and can be suitably changed without departing from the spirit and scope of the present disclosure.

In the foregoing example, the program includes a command set (or software code) for causing a computer to execute one or more of the functions described in the embodiment, when read by the computer. The program may be stored in a non-transitory computer-readable medium or in a tangible storage medium. The computer-readable medium or the tangible storage medium includes, for example but not limited to, a random-access memory (RAM), a read-only memory (ROM), a flash memory, a solid-state drive (SSD), other memory techniques, a CD-ROM, a digital versatile disc (DVD), a Blu-ray (trademark registered) disk, other optical disk storages, a magnetic cassette, a magnetic tape, a magnetic disk storage or other magnetic storage devices. The program may be transmitted on a transitory computer-readable medium or a communication medium. The transitory computer-readable medium or the communication medium includes, for example but not limited to, a propagating signal in an electrical, optical, acoustic or other formats.

A part or the entirety of the foregoing embodiment can be described as in Supplementary Notes given below but are not limited to the description below.

### Supplementary Note 1

A terminal device includes: a first communication processing unit that establishes a wireless communication connection according to a first wireless communication scheme; a transmission control unit that performs control to transmit, to a wireless communication device, instruction information giving an instruction to execute a function installed in the wireless communication device, using the wireless communication connection according to the first wireless communication scheme; a second communication processing unit that establishes, with the wireless communication device, a wireless communication connection according to a second wireless communication scheme that is a communication scheme conforming to a NAN (Neighbor Awareness Networking) standard and that is different from the first wireless communication scheme; and a state information acquisition unit that acquires state information representing of a state the wireless communication device from the wireless communication device, using the wireless communication connection according to the second wireless communication scheme, when a response to the instruction information is not given.

### Supplementary Note 2

The terminal device according to Supplementary Note 1 further includes a display control unit that performs control to display the state information.

### Supplementary Note 3

In the terminal device according to Supplementary Note 1 or 2, the state information includes information representing a result of a diagnosis by the wireless communication device about the state of the wireless communication connection according to the first wireless communication scheme of the wireless communication device.

### Supplementary Note 4

In the terminal device according to Supplementary Note 2, the state information includes information representing a result of a diagnosis by the wireless communication device about the state of the wireless communication connection according to the first wireless communication scheme of the wireless communication device. The state information acquisition unit further acquires reference information that is information which a user should refer to in order to solve a defect in the wireless communication connection according to the first wireless communication scheme of the wireless communication device, along with the result of the diagnosis, from the wireless communication device, using the wireless communication connection according to the second wireless communication scheme. The display control unit further performs control to display the reference information.

### Supplementary Note 5

In the terminal device according to Supplementary Note 2, the state information includes information representing a result of a diagnosis by the wireless communication device about the state of the wireless communication connection according to the first wireless communication scheme of the wireless communication device. The terminal device includes a storage unit that stores reference information that is information which a user should refer to in order to solve a defect in the wireless communication connection according to the first wireless communication scheme of the wireless communication device. The display control unit further performs control to display the reference information corresponding to the result of the diagnosis.

### Supplementary Note 6

In the terminal device according to one of Supplementary Notes 1 to 5, the transmission control unit further performs control to transmit the instruction information to the wireless communication device, using the wireless communication connection according to the second wireless communication scheme, when a response to the instruction information is not given.

### Supplementary Note 7

In the terminal device according to Supplementary Note 6, the state information includes information representing a state about the function of the wireless communication device. The transmission control unit performs control not to transmit the instruction information to the wireless communication device, using the wireless communication connection according to the second wireless communication scheme, when the state information indicates an abnormality in the function.

### Supplementary Note 8

In the terminal device according to Supplementary Note 2, the state information includes information about a remaining amount of a consumable item installed in the wireless communication device in order to execute the function. The display control unit further performs control to display a warning that gives a notification of a shortage of the consumable item, when the state information indicates the shortage of the consumable item.

### Supplementary Note 9

In the terminal device according to one of Supplementary Notes 1 o 8, the second communication processing unit specifies a connection target of the wireless communication connection according to the second wireless communication scheme, based on a MAC (media access control) address of the wireless communication device that is a destination of transmission of the instruction information.

### Supplementary Note 10

A control method for a terminal device includes: performing control to transmit, to a wireless communication device, instruction information giving an instruction to execute a function installed in the wireless communication device, using a wireless communication connection according to a first wireless communication scheme; establishing, with the wireless communication device, a wireless communication connection according to a second wireless communication scheme that is a communication scheme conforming to a NAN standard and that is different from the first wireless communication scheme; and acquiring state information representing a state of the wireless communication device from the wireless communication device, using the wireless communication connection according to the second wireless communication scheme, when a response to the instruction information is not given.

### Supplementary Note 11

A non-transitory computer-readable storage medium storing a program is provided. The program causes a computer to execute: a first communication processing step of establishing a wireless communication connection according to a first wireless communication scheme; a transmission control step of performing control to transmit, to a wireless communication device, instruction information giving an instruction to execute a function installed in the wireless communication device, using the wireless communication connection according to the first wireless communication scheme; a second communication processing step of establishing, with the wireless communication device, a wireless communication connection according to a second wireless communication scheme that is a communication scheme conforming to a NAN standard and that is different from the first wireless communication scheme; and a state information acquisition step of acquiring state information representing a state of the wireless communication device from the wireless communication device, using the wireless communication connection according to the second wireless communication scheme, when a response to the instruction information is not given.

What is claimed is:

1. A terminal device comprising:
a first communication processor that establishes a wireless communication connection according to a first wireless communication scheme;
a transmission controller that performs control to transmit, to a wireless communication device, instruction information giving an instruction to execute a function installed in the wireless communication device, using the wireless communication connection according to the first wireless communication scheme;
a second communication processor that establishes, with the wireless communication device, a wireless communication connection according to a second wireless communication scheme that is a communication scheme conforming to a NAN (Neighbor Awareness Networking) standard and that is different from the first wireless communication scheme; and
a state information acquisition unit that acquires state information representing a state of the wireless communication device from the wireless communication device, using the wireless communication connection according to the second wireless communication scheme, when a response to the instruction information is not given.

2. The terminal device according to claim 1, further comprising:
a display controller that performs control to display the state information.

3. The terminal device according to claim 1, wherein
the state information includes information representing a result of a diagnosis by the wireless communication device about the state of the wireless communication connection according to the first wireless communication scheme of the wireless communication device.

4. The terminal device according to claim 2, wherein
the state information includes information representing a result of a diagnosis by the wireless communication device about the state of the wireless communication connection according to the first wireless communication scheme of the wireless communication device,
the state information acquisition unit further acquires reference information that is information which a user should refer to in order to solve a defect in the wireless communication connection according to the first wireless communication scheme of the wireless communication device, along with the result of the diagnosis, from the wireless communication device, using the wireless communication connection according to the second wireless communication scheme, and
the display controller further performs control to display the reference information.

5. The terminal device according to claim 2, wherein
the state information includes information representing a result of a diagnosis by the wireless communication device about the state of the wireless communication connection according to the first wireless communication scheme of the wireless communication device,
the terminal device includes a storage that stores reference information that is information which a user should refer to in order to solve a defect in the wireless communication connection according to the first wireless communication scheme of the wireless communication device, and
the display controller further performs control to display the reference information corresponding to the result of the diagnosis.

6. The terminal device according to claim 1, wherein
the transmission controller further performs control to transmit the instruction information to the wireless communication device, using the wireless communication connection according to the second wireless communication scheme, when a response to the instruction information is not given.

7. The terminal device according to claim 6, wherein
the state information includes information representing a state about the function of the wireless communication device, and
the transmission controller performs control not to transmit the instruction information to the wireless communication device, using the wireless communication connection according to the second wireless communication scheme, when the state information indicates an abnormality in the function.

8. The terminal device according to claim 2, wherein
the state information includes information about a remaining amount of a consumable item installed in the wireless communication device in order to execute the function, and
the display controller further performs control to display a warning that gives a notification of a shortage of the consumable item, when the state information indicates the shortage of the consumable item.

9. The terminal device according to claim 1, wherein
the second communication processor specifies a connection target of the wireless communication connection according to the second wireless communication scheme, based on a MAC (media access control) address of the wireless communication device that is a destination of transmission of the instruction information.

10. A control method for a terminal device comprising:
performing control to transmit, to a wireless communication device, instruction information giving an instruction to execute a function installed in the wireless communication device, using a wireless communication connection according to a first wireless communication scheme;
establishing, with the wireless communication device, a wireless communication connection according to a second wireless communication scheme that is a communication scheme conforming to a NAN standard and that is different from the first wireless communication scheme; and
acquiring state information representing a state of the wireless communication device from the wireless communication device, using the wireless communication connection according to the second wireless communication scheme, when a response to the instruction information is not given.

11. A non-transitory computer-readable storage medium storing a program, the program causing a computer to execute:
a first communication processing step of establishing a wireless communication connection according to a first wireless communication scheme;
a transmission control step of performing control to transmit, to a wireless communication device, instruction information giving an instruction to execute a function installed in the wireless communication device, using the wireless communication connection according to the first wireless communication scheme;
a second communication processing step of establishing, with the wireless communication device, a wireless communication connection according to a second wireless communication scheme that is a communication scheme conforming to a NAN standard and that is different from the first wireless communication scheme; and
a state information acquisition step of acquiring state information representing a state of the wireless communication device from the wireless communication device, using the wireless communication connection according to the second wireless communication scheme, when a response to the instruction information is not given.
